(19) United States
(12) Patent Application Publication
(10) Pub. No.: US 2013/0234454 A1
(43) Pub. Date: Sep. 12, 2013

(54) Stayzopen

(71) Applicant: Michael Axelsen, Freeport, FL (US)

(72) Inventor: Michael Axelsen, Freeport, FL (US)

(21) Appl. No.: 13/790,626

(22) Filed: Mar. 8, 2013

Related U.S. Application Data
(60) Provisional application No. 61/608,975, filed on Mar. 9, 2012.

(51) Int. Cl. E05C 17/02

(52) U.S. Cl. CPC E05C 17/02
USPC 292/305

(57) ABSTRACT

A door latch device is disclosed that can attach to a wall in order to hold any door open by the handle. The door latch device comprises a threaded rod component that is screwed directly into a wall. The door latch device further comprises an engaging member for engaging a door handle to hold the door in an open position. The engaging member is a thin protrusion for engaging a lever-style door handle, or a thin curved protrusion for engaging a round knob door handle. The door latch device also comprises a securing component for locking the threaded rod component into a wall. The securing component locks the threaded rod component at a specific distance from the wall and at a level of the door handle, such that the door latch device engages the door handle when the door is in an open position.

### CROSS-REFERENCE

This application claims priority from Provisional Patent Application Ser. No. 61/608,975 filed Mar. 9, 2012.

### BACKGROUND

Oftentimes individuals may need to navigate between rooms in a home, apartment, business, or school while cleaning, mopping, or vacuuming, but doors that don't stay open on their own can get in the way. Furthermore, young children can become injured by a door that is left ajar, or by a door that accidentally closes on them. Also, it can be difficult to move quickly and efficiently between rooms, especially for individuals who have their hands full and who have no easy way to hold the door open manually. Generally, door stops are inefficient and frequently scuff up the floor or do not securely hold the door open. Thus, a simple yet reliable device for holding a door open is necessary.

There is a need for a device that helps improve convenience and safety in the home or office by providing a simple and effective way of holding a door open. The present invention is aesthetically pleasing and can be easily installed behind a door and can be used in homes, offices, schools, businesses, or virtually any location with lever and knob-style door handles. The door latch device can help improve efficiency in the home by providing an easy way to hold open any door conveniently and effectively. Doors can be held open to facilitate convenient vacuuming, mopping, and general cleaning between rooms, as well as easy movement between rooms when hands are full. With minimal effort, the door handle can easily latch over the door latch device so that children and pets cannot accidentally run into a door that is left ajar. The door latch device would be beneficial to all home or apartment owners, as well as any facility with doors that need to remain open occasionally.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a door latch device that can be removably attached to a wall in order to hold any door open by the handle. The door latch device comprises a rod component comprising a first end and a second end. The rod component is a threaded rod component that is screwed directly into a wall or other vertical surface. The door latch device further comprises an engaging member secured to the first end of the threaded rod for engaging a door handle to hold the door in an open position. The engaging member is a thin protrusion for engaging a lever-style door handle, or a thin curved protrusion for engaging a round knob door handle.

In a preferred embodiment, the door latch device comprises a securing component removably attached to the second end of the threaded rod for locking the threaded rod component into a wall. The securing component comprises at least one jam nut and a washer for securing the door latch device to a wall stud. Further, the securing component comprises a butterfly-style nut for securing the door latch device to drywall. Additionally, the securing component locks the threaded rod component at a specific distance from the wall and at a level of the door handle, such that the door latch device engages the door handle when the door is in an open position.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1A illustrates a perspective view of the door latch device used with a round knob door handle in accordance with the disclosed architecture.

FIG. 1B illustrates a perspective view of the door latch device used with a lever-style door handle in accordance with the disclosed architecture.

FIG. 2A illustrates a perspective view of the door latch device engaging a lever-style door handle in accordance with the disclosed architecture.

FIG. 2B illustrates a perspective view of the door latch device engaging a round knob door handle in accordance with the disclosed architecture.

FIGS. 3A-D illustrate a perspective view of a plurality of different embodiments of the door latch device of the present invention in accordance with the disclosed architecture.

FIG. 4 illustrates a perspective view of the door latch device in use with a lever-style door handle in accordance with the disclosed architecture.

FIG. 5 illustrates a perspective view of the door latch device in use with a round knob door handle in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

A door latch device is disclosed that can be easily and cleanly installed behind a door and can be used in homes, offices, schools, businesses, or virtually any location with lever and knob-style door handles. The door latch device can help improve efficiency in the home by providing an easy way to hold open any door conveniently and effectively. With minimal effort, the door handle can easily latch over the door latch device so that children and pets cannot accidentally run into a door that is left ajar. The door latch device would be beneficial to all home or apartment owners, as well as any facility with doors that need to remain open occasionally.

The door latch device comprises a threaded rod component that is screwed directly into a wall or other vertical surface. The door latch device further comprises an engaging member for engaging a door handle to hold the door in an open position. The engaging member is a thin protrusion for engaging a lever-style door handle, or a thin curved protrusion for engaging a round knob door handle. The door latch device also comprises a securing component for securely attaching the threaded rod component into a wall. The securing component locks the threaded rod component at a desired distance from the wall and at a level of the door handle, such that the door latch device is capable of engaging the door handle when the door is in an open position.

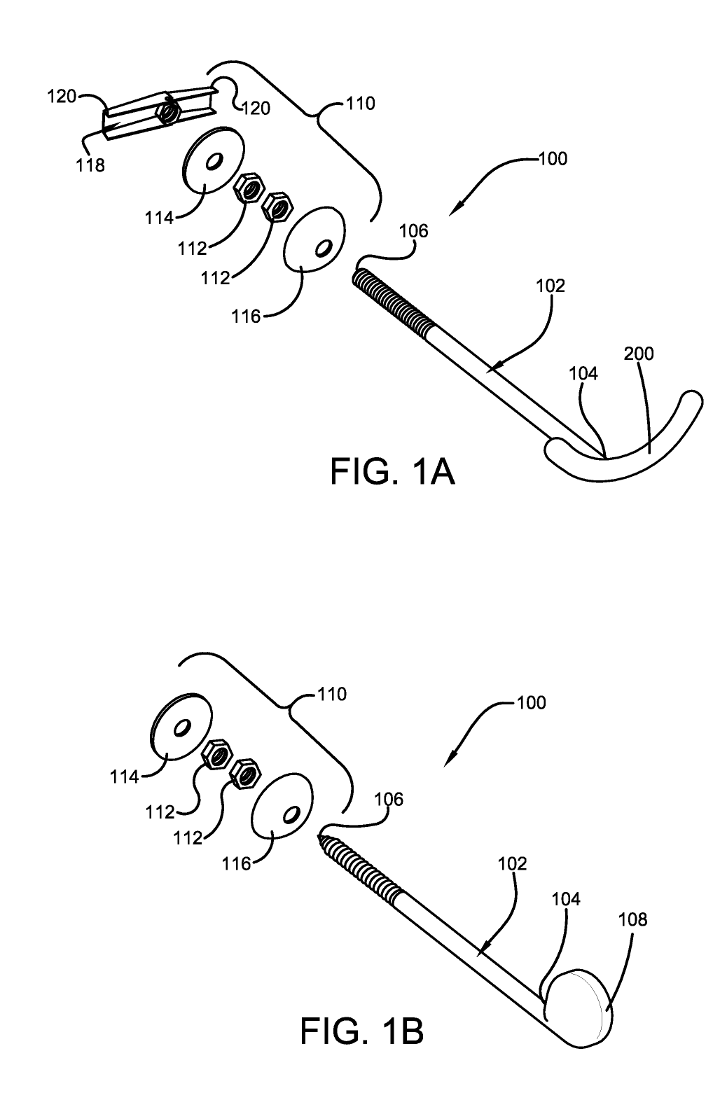

Referring initially to the drawings, FIGS. 1A-B and 2A-B illustrate a door latch device 100 that can attach to a wall in order to hold any door open by the handle. The door latch device 100 comprises a rod component 102 comprising a first end 104 and a second end 106. The rod component 102 is a threaded rod component that is screwed directly into a wall or other vertical surface. Typically, the threaded rod component 102 is cylindrical in shape, however any other suitable shape, functional or ornamental, can be used as is known in the art without affecting the overall concept of the invention.

The threaded rod component 102 would generally be constructed of steel, aluminum, chrome-plated steel, zinc-plated steel, or any other similar metal, etc., though any other suitable material may be used to manufacture the threaded rod component 102 as is known in the art without affecting the overall concept of the invention. The threaded rod component 102 can also comprise a variety of colors and designs to suit user and manufacturing preference. The threaded rod component 102 is approximately between 3.0 and 7.0 inches long as measured from the first end 104 to the second end 106, and approximately between ⅛ and ⅝ inches in diameter. Typically, the threaded rod component 102 is solid, but it does not have to be and can function by being partly or wholly hollow.

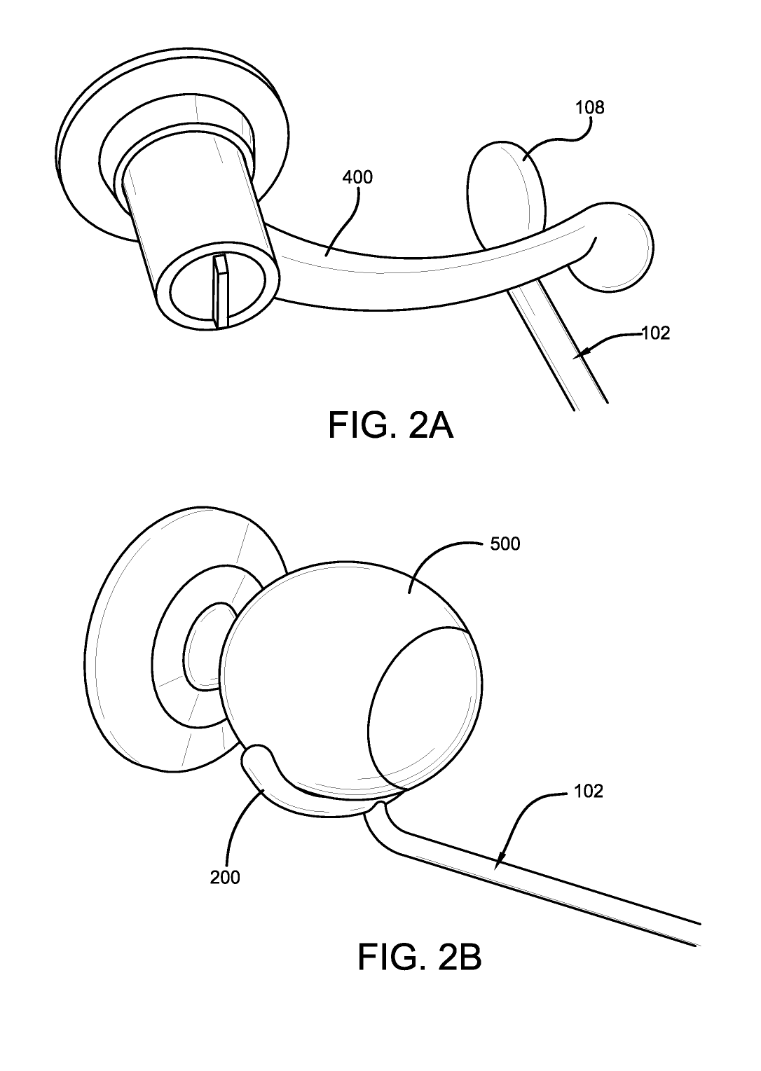

The door latch device 100 further comprises an engaging member (108 and 200 as shown in FIGS. 2A and 2B) secured to the first end 104 of the threaded rod 102 for engaging a door handle (not shown) to hold the door in an open position. The engaging member 108 is a thin protrusion for engaging a lever-style door handle, or the engaging member 200 is a thin curved protrusion for engaging a round knob door handle. However, the engaging member 108 or 200 can be any suitable shape or structure as is known in the art as long as the engaging member 108 or 200 contacts (or engages) a door handle to hold the door in an open position. Typically, for a lever-style door handle, the thin protrusion contacts the underside of the door handle, restraining it from movement (as shown in FIG. 2A). Additionally, for a round knob door handle, the thin curved protrusion contacts the underside of the round knob, restraining it from movement (as shown in FIG. 2B). However, the engaging member 108 or 200 can contact (engage) the door handle at any suitable position on the door handle as is known in the art.

Further, the engaging member 108 or 200 can be manufactured as an integral piece with the threaded rod component 102 but it does not have to be, and the device 100 can function with the engaging member 108 or 200 being a separate component and being secured to the threaded rod component 102. Specifically, the engaging member 108 and 200 is secured to the threaded rod component 102 via welding, gluing, threading, etc., or any other suitable securing means as is known in the art without affecting the overall concept of the invention.

The engaging member 108 or 200 would generally be constructed of steel, aluminum, chrome-plated steel, zinc-plated steel, or any other similar metal, etc., though any other suitable material may be used to manufacture the engaging member 108 or 200 as is known in the art without affecting the overall concept of the invention. Typically, the engaging member 108 or 200 would be constructed of the same material as the threaded rod component 102.

The door latch device 100 further comprises a securing component 110 (as shown in FIGS. 1A and 1B) removably attached to the second end 106 of the threaded rod 102 for locking (or securely attaching) the threaded rod component 102 into a wall (not shown). The securing component 110 comprises at least one jam nut 112 and a washer 114 for securing the door latch device 100 to a wall stud (as shown in FIG. 1B). Typically, there are two jam nuts 112 that lock together to prevent the threaded rod component 102 from pulling out of the wall, however the door latch device 100 can function with as few as one jam nut 112. Further, a cover 116 can be threaded onto the rod component 102 to cover the jam nuts 112 from view and to provide the door latch device 100 with an aesthetically pleasing appearance.

The securing component 110 can also comprise a butterfly-style nut 118 for securing the door latch device 100 to drywall (as shown in FIG. 1A). The butterfly-style nut 118 is a typical butterfly-style nut as is known in the art and is threaded onto the second end 106 of the rod component 102 and closed via its hinges. Once inserted into a hole in the drywall, the butterfly-style nut is opened which pulls against the backside of the drywall, securing the rod component 102 into the wall. However, the securing component 110 can be any suitable fasteners as are known in the art as long as the securing component 110 locks the threaded rod component 102 into a wall stud, drywall, or other structure.

Further, the securing component 110 locks the threaded rod component 102 at a specific desired distance from the wall and at a level of the door handle. A user would insert the threaded rod component 102 at a specific distance from the wall, depending on the distance of the door handle from the door. The threaded rod component 102 would also be inserted into the wall at a level of the door handle, such that the door latch device 100 is capable of engaging or contacting the door handle when the door is in an open position. Once inserted into the wall at the desired height from the ground and distance from the wall, the securing component 110 locks the threaded rod component 102 into place in the wall.

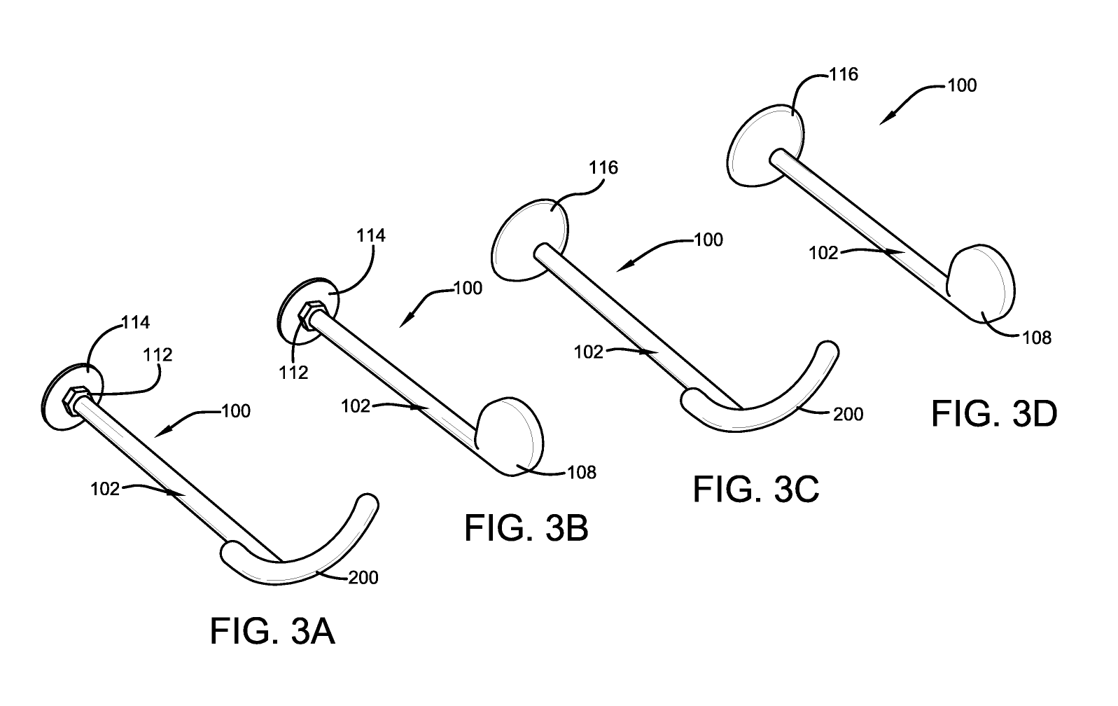

FIGS. 3A-D illustrate a plurality of door latch devices 100. As stated supra, the door latch device 100 comprises a threaded rod component 102 that is screwed directly into a wall or other vertical surface. The door latch device 100 further comprises an engaging member 108 and 200 secured to a first end of the threaded rod 102 for engaging a door handle to hold the door in an open position. The engaging member 108 is a thin protrusion for engaging a lever-style door handle (as shown in FIGS. 3B and 3D), or the engaging member 200 is a thin curved protrusion for engaging a round knob door handle (as shown in FIGS. 3A and 3C).

Furthermore, the door latch device 100 comprises a securing component 110 removably attached to a second end of the threaded rod 102 for locking the threaded rod component 102 into a wall. The securing component 110 comprises at least one jam nut 112 and a washer 114 for securing the door latch device 100 to a wall stud or other solid wall structures. Further, the securing component 110 comprises a butterfly-style nut 118 for securing the door latch device 100 to drywall or other hollow wall structures. Further, a cover 116 can be threaded onto the rod component 102 to cover the jam nuts 112 and to provide the door latch device 100 with an aesthetically pleasing appearance. However, the cover 116 is not necessary and the door latch device 100 can function without the use of the cover 116 (as shown in FIGS. 3A-B).

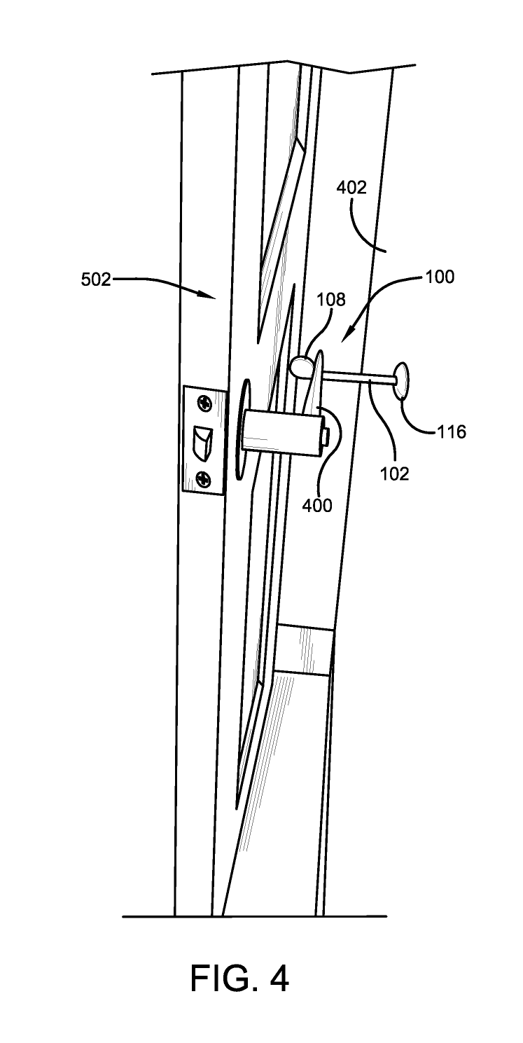

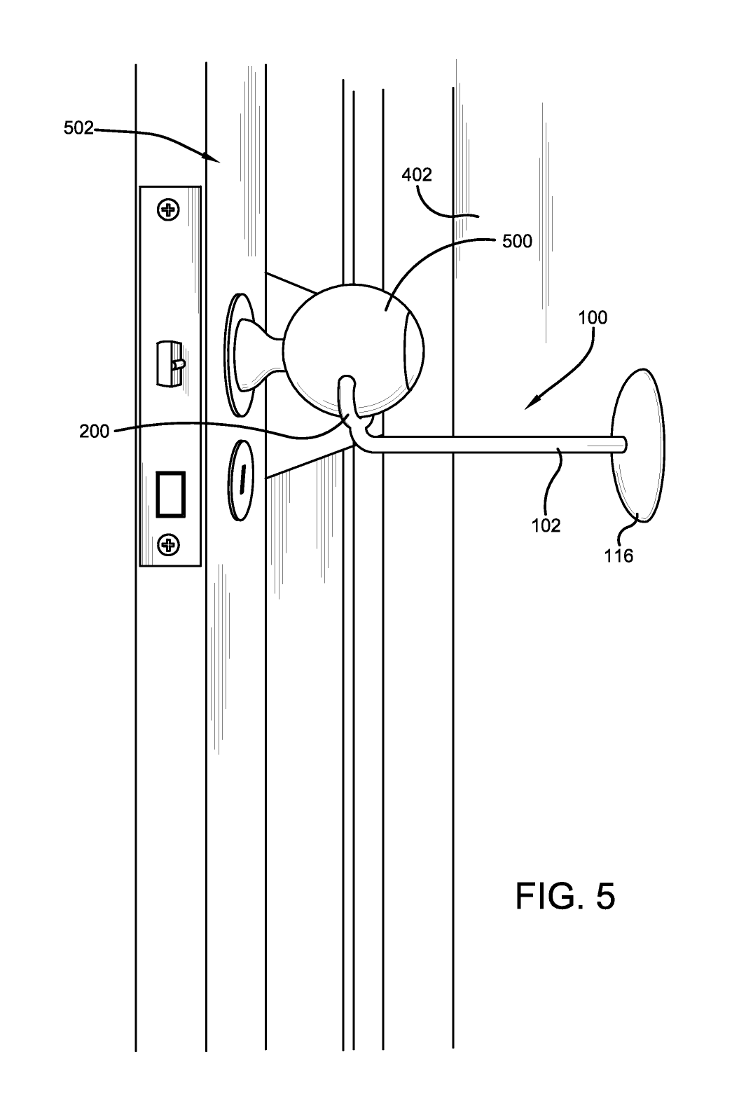

FIGS. 4-5 illustrate the door latch device 100 in use. In operation, a user (not shown) would choose the color and/or specific design of the door latch device 100 that meets their needs and/or wants. The user would then determine what type of door handle is on the door 502 they want to hold open. If the door handle is a lever-style door handle 400 (as shown in FIG. 4), then the user would choose a door latch device 100 comprising an engaging member 108, wherein the engaging member 108 is a thin protrusion for engaging a lever-style door handle 400. If the door handle is a round knob door handle 500 (as shown in FIG. 5), then the user would choose a door latch device 100 comprising an engaging member 200, wherein the engaging member 200 is a thin curved protrusion for engaging a round knob door handle 500. Once the user has chosen the appropriate door latch device 100, the user would insert the door latch device 100 into the wall 402.

The door latch device 100 is inserted into the wall 402 via the threaded rod 102. First, a user would attach a securing component 110 to an end of the threaded rod 102 for locking the threaded rod component 102 into the wall 402. If the threaded rod 102 is being secured into a wall stud or other solid wall, then the user would attach two jam nuts 112 and a washer 114 on the threaded rod component 102, for securing the door latch device 100 to a wall stud. Further, a user can also attach a cover 116 onto the rod component 102 to cover the jam nuts 112 and to provide the door latch device 100 with an aesthetically pleasing appearance.

First, a user threads on the cover 116, the two jam nuts 112, and the washer 114 to the rod component 102. The user then threads the rod component 102 into the wall 402 at a specific distance from the wall 402, depending on the distance of the door handle from the door 502. The threaded rod component 102 would also be inserted into the wall 402 at a level of the door handle, such that the door latch device 100 would engage or contact the door handle when the door 502 is in an open position. Once the user inserts the threaded rod component 102 into the wall at the desired height from the ground and distance from the wall, the user threads the cover 116, the two jam nuts 112 and the washer 114 toward the surface of the wall, locking the threaded rod component 102 into place in the wall 402.

If the threaded rod 102 is being secured into drywall or other hollow wall structures, then the user would attach a butterfly-style nut 118, two jam nuts 112 and a washer 114 on the threaded rod component 102, for securing the door latch device 100 to the hollow wall. Further, a user can also attach a cover 116 onto the rod component 102 to cover the jam nuts 112 and to provide the door latch device 100 with an aesthetically pleasing appearance.

First, a user threads on the cover 116, the two jam nuts 112, the washer 114, and the butterfly-style nut 118 to the rod component 102. The user then drills a hole in the drywall at a specific distance from the wall 402, depending on the distance of the door handle from the door 502, and at a level of the door handle, such that the door latch device 100 would engage or contact the door handle when the door 502 is in an open position. The user then closes the butterfly-style nut 118 via closing its hinges toward the rod component 102, and inserts the butterfly-style nut 118 into the hole in the drywall along with the rod component 102.

Once the user inserts the butterfly-style nut 118 into the hole in the drywall, the butterfly-style nut is opened which allows its ends 120 to push against the backside of the drywall, securing the rod component 102 into the wall. Then, the user threads the cover 116, the two jam nuts 112 and the washer 114 toward the surface of the wall, locking the threaded rod component 102 into place in the wall 402. Once the door latch device 100 is inserted into the wall 402 at the desired height from the ground and distance from the wall and locked in place, the user opens the door 502 and latches the door handle to the door latch device 100, securing the door in an open position.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A door latch device, comprising:
a threaded rod component comprising a first end and a second end;
an engaging member secured to the first end; and
a securing component removably attached to the second end; and
wherein the securing component locks the threaded rod component into a static structure; and
wherein the engaging member engages a door handle to hold the door in an open position.

2. The door latch device of claim 1, wherein the engaging member comprises a thin protrusion for engaging a lever-style door handle.

3. The door latch device of claim 1, wherein the engaging member comprises a thin curved protrusion for engaging a knob-style door handle.

4. The door latch device of claim 1, wherein the securing component comprises at least one fastener for locking the door latch device to the static structure.

5. The door latch device of claim 1, wherein the securing component comprises at least one nut, a washer, and a butterfly-style nut for locking the door latch device to the static structure.

6. The door latch device of claim 1, wherein the securing component locks the threaded rod component at a specific distance from the static structure and at a level of the door handle.

7. The door latch device of claim 1, wherein the door latch device is approximately six inches in length.

8. The door latch device of claim 1, wherein the door latch device is manufactured from at least one of steel, aluminum, chrome-plated steel, or zinc-plated steel.

9. A door latch device, comprising:
a threaded rod component comprising a first end and a second end;
a thin protrusion for engaging a lever-style door handle secured to the first end; and
a securing component removably attached to the second end; and
wherein the securing component locks the threaded rod component into a wall; and
wherein the thin protrusion engages a door handle to hold the door in an open position.

10. The door latch device of claim 9, wherein the door latch device is approximately six inches in length.

11. The door latch device of claim 9, wherein the door latch device is manufactured from at least one of steel, aluminum, chrome-plated steel, or zinc-plated steel.

12. The door latch device of claim 9, wherein the securing component comprises at least one nut and a washer for locking the door latch device to a wall stud.

13. The door latch device of claim 9, wherein the securing component comprises at least one nut, a washer, and a butterfly-style nut for locking the door latch device to drywall.

14. The door latch device of claim 9, wherein the securing component locks the threaded rod component at a specific distance from the wall and at a level of the door handle.

15. A door latch device, comprising:
a threaded rod component comprising a first end and a second end;
a thin curved protrusion for engaging a knob-style door handle secured to the first end; and
a securing component removably attached to the second end; and
wherein the securing component locks the threaded rod component into a wall; and
wherein the thin curved protrusion engages a door handle to hold the door in an open position.

16. The door latch device of claim 15, wherein the securing component comprises at least one nut and a washer for locking the door latch device to a wall stud.

17. The door latch device of claim 15, wherein the securing component comprises at least one jam nut, a washer, and a butterfly-style nut for locking the door latch device to drywall.

18. The door latch device of claim 15, wherein the door latch device is approximately six inches in length.

19. The door latch device of claim 15, wherein the door latch device is manufactured from at least one of steel, aluminum, chrome-plated steel, or zinc-plated steel.

20. The door latch device of claim 15, wherein the securing component locks the threaded rod component at a specific distance from the wall and at a level of the door handle.
